(19) United States
(12) Patent Application Publication
(10) Pub. No.: US 2010/0140203 A1
(43) Pub. Date: Jun. 10, 2010

(54) Skeleton structure bottle with removable chambers and method of manufacturing the same

(76) Inventor: Theodosios Kountotsis, East Elmhurst, NY (US)

Correspondence Address: Theodosios Kountotsis, 32-31 72 Street, East Elmhurst, NY, 11370, US

(21) Appl. No.: 12/315,790

(22) Filed: Dec. 5, 2008

(51) Int. Cl. B65D 6/00; B23P 17/04

(52) U.S. Cl. 215/6; 29/592

(57) ABSTRACT

A bottle including a first portion having one or more bottle openings; a second portion being a base portion; and a body portion extending from the second portion to the first portion, the body portion configured to be a skeleton structure; wherein the skeleton structure is configured to receive one or more removable chambers.

### BACKGROUND

1. Field of the Related Art

The present disclosure relates to bottles, and more particularly, but not exclusively, to a skeleton structure bottle having replaceable/removable/interchangeable chambers for separately dispensing liquids and for promoting environmental friendliness.

2. Description of the Related Art

Liquid storage containers have been provided in numerous shapes and sizes for various liquid commodities. The most ubiquitous liquid storage containers are presently plastic and provide multiple shapes and sizes with mass production capability and recyclable materials. A popular liquid storage container is a drinking bottle. Typically, most individuals utilize a drinking bottle formed of a molded plastic material. The most common type of molded plastic drinking bottle employs a neck portion supporting a removable cap and a chamber connected to the neck portion. These plastic drinking bottles are reasonably durable, are reusable with most liquid drinks of choice, are economical to make and to purchase, and are easy to use (in that an individual can grip the bottle with one hand and take a drink via the outlet means without spilling the liquid).

In particular, sports bottles have become very popular over the years as molded plastic drinking bottles. Sports bottles are containers which generally have a removable lid, are relatively tall and easy to hold and have a cap or lid positioned at the top portion of the sports bottle. Sports bottles have become quite popular given the increased exercise activity of individuals. Sports bottles are convenient because they do not leak and can be readily carried or placed without fear of spilling the liquid contained therein. To use a sports bottle, one simply places the desired liquid in the sport bottle and closes the lid and/or inserts a straw. Thereafter, whenever it is desired to acquire liquid, one merely opens the lid to allow access to the liquid.

Many individuals who exercise are interested in workouts of extended durations, at various levels of intensity. Thus, many individuals have available or even carry several individual bottles of water or other liquids to replenish body liquids lost from sweating. These individuals may particularly seek to take more than one type of drink while maintaining the same exercise pace and without carrying multiple bottles containing different liquids. Thus, many individuals may desire more than one type of drink to replenish body liquids lost from sweating when engaging in one or more intense workout activities, without inadvertently mixing the liquids.

Furthermore, one of the most critical needs facing individuals engaged in sports is the continuous supply or intake of different liquids (e.g., drinking water, sports drinks, energy drinks, protein shakes, etc.) while they exercise. During extended exercise activities, individuals face serious dehydration problems and the loss of competitive capability unless they continuously replenish the fluids lost during such exercise activities. However, the human body requires many different types of vitamins or minerals that cannot all be found in one type of liquid. As a result, once again, individuals may desire more than one type of drink to replenish body liquids lost from sweating when engaging in one or more intense workout activities, without inadvertently mixing the liquids, in order to replenish several types of vitamins and minerals.

Moreover, sports enthusiasts are typically becoming more aware of the benefits of combining the use of electrolyte replacing sports drinks and/or water and/or protein shakes for ultimate performance enhancement and refreshment. Additionally, even children/teenagers often desire to consume more than a single flavor of soft drink or juices or any other type of desirable liquid. Also, adults who consume caffeinated energy drinks frequently purchase bottled water to compliment the energy drink in order to quench their thirst. In other words, such individuals must carry two or more bottles to quench their thirst. Thus, there is a need to provide a bottle that is capable of dispensing more than one type of liquid separately, without inadvertently mixing the liquids. There is also a need to provide an environmentally-friendly multi-chambered bottle that may be used several hundred or even thousand times without discarding it into the trash.

Consequently, traditional sports bottles present a limitation in that they do not allow an individual to enjoy a plurality of different liquid drinks separately from each other, without mixing the liquids, and at the same time period. Presently, many multi-chambered bottle systems lack the ability to effectively provide two or more liquids to an individual without mixing the liquid contents. In addition, another limitation is the fact that an individual must carry a plurality of bottles, each of the plurality of bottles containing different liquids. Furthermore, another limitation involves the ability to limit the consumption of plastic materials used in manufacturing drinking bottles, which results in disastrous environmental effects for the planet.

Traditional multi-chambered bottles do not provide for effective means of purposely separating two or more liquids desired to be consumed by an individual. In other words, traditional multi-chambered bottles allow for inadvertent mixing of liquids, even though the individual desires to consume only one drink at a time. Thus, despite other practitioners' efforts to provide improved systems, there remains nonetheless a continuing need in the art for an improved liquid supply apparatus for use by individuals, such as, but not limited to, individuals engaged in sports or exercise activities.

The present disclosure is intended to overcome the drawbacks of conventional multi-chambered bottle systems by exploiting bottle morphology in order to successfully separate liquids without allowing inadvertent mixing of liquids. It is desirable to provide a single container having multiple elements for storage of different commodities and a means for selecting between them during consumption. It is further desirable that such a container be easily manufactured, filled, and assembled. In particular, the present disclosure relates to a bottle for separately providing two or more liquids to an individual, without mixing the liquids. The present disclosure further relates to a method of manufacturing a multi-chambered bottle that prevents the inadvertent mixture of liquids by providing for environmentally friendly, removable liquid components.

### SUMMARY

The present disclosure provides a bottle including a first portion having one or more bottle openings; a second portion being a base portion; and a body portion extending from the second portion to the first portion, the body portion configured to be a skeleton structure; wherein the skeleton structure is configured to receive one or more removable chambers.

The present disclosure provides a removable chamber including a first removable chamber portion having an opening; a second removable chamber portion being a base portion; and a third removable chamber portion extending from the second removable chamber portion to the first removable chamber portion; wherein the removable chamber is configured to be securedly fixed within a bottle having a skeleton structure.

The present disclosure also provides a method for manufacturing a bottle, the method including the steps of forming a first portion having one or more bottle openings; forming a second portion being a base portion; and forming a body portion extending from the second portion to the first portion, the body portion configured to be a skeleton structure; wherein the skeleton structure is configured to receive one or more removable chambers.

Further scope of applicability of the present disclosure will become apparent from the detailed description given hereinafter. However, it should be understood that the detailed description and specific examples, while indicating preferred embodiments of the present disclosure, are given by way of illustration only, since various changes and modifications within the spirit and scope of the invention will become apparent to those skilled in the art from this detailed description.

### BRIEF DESCRIPTION OF THE DRAWINGS

Various embodiments of the present disclosure will be described herein below with reference to the figures wherein:

FIG. 1 is a perspective view of a skeleton structure bottle having a central member and two side members for receiving two removable chambers, each removable chamber containing a different liquid, in accordance with the present disclosure;

FIG. 1A is an exploded view of the skeleton structure of FIG. 1 having a removable cap with two fixed orifices, in accordance with the present disclosure;

FIG. 2 is a perspective view of dual chambers configured to be securedly fixed to the skeleton structure bottle of FIG. 1, in accordance with the present disclosure;

FIG. 3 is a perspective view of a skeleton structure bottle having a central member and two side members for receiving two removable chambers, each removable chamber containing a different liquid and each side member being an inwardly curved structure, in accordance with the present disclosure;

FIG. 4 is a perspective view of dual chambers configured to be securedly fixed to the skeleton structure bottle of FIG. 3, in accordance with the present disclosure;

FIG. 5 is a perspective view of a skeleton structure bottle having a central member and two side members for receiving two removable chambers, each removable chamber containing a different liquid and each side member being an outwardly curved structure, in accordance with the present disclosure;

FIG. 6 is a perspective view of a skeleton structure bottle having a central member and three side members for receiving three removable chambers, each removable chamber containing a different liquid, in accordance with the present disclosure;

FIG. 7 is a perspective view of a skeleton structure bottle having four side members for receiving four removable chambers, each removable chamber containing a different liquid, in accordance with the present disclosure;

FIG. 8A is a perspective view of a removable cap having a fixed switchable orifice connected to the skeleton structure bottle of FIG. 1, in accordance with the present disclosure;

FIG. 8B is a perspective view of a removable cap having a fixed slidable orifice connected to the skeleton structure bottle of FIG. 1, in accordance with the present disclosure;

FIG. 9 is a top view of the top portion of the skeleton structure of FIG. 1 illustrating the gap portion for preventing the inadvertent mixture of liquids, in accordance with the present disclosure;

FIG. 10 is a perspective view of a skeleton structure bottle having a single cooling element, in accordance with the present disclosure; and

FIG. 11 is a perspective view of a skeleton structure bottle having two cooling elements, in accordance with the present disclosure.

### DETAILED DESCRIPTION

Unless otherwise indicated, all numbers expressing quantities and conditions, and so forth used in the specification and claims are to be understood as being modified in all instances by the term “about.” In this application, the use of the singular includes the plural unless specifically stated otherwise. In this application, the use of “or” means “and/or” unless stated otherwise. Furthermore, the use of the term “including,” as well as other forms, such as “includes” and “included,” is not limiting. Also, terms such as “element” or “component” encompass both elements and components comprising one unit and elements and components that comprise more than one subunit unless specifically stated otherwise.

The term “component,” “element,” and/or “device” may be defined herein as a constituent element of a system. The term “component” can also refer to an identifiable part of a larger program, system or construction. A system, as described with respect to the present disclosure, may be divided into several components. A component can be one element of a larger system. Usually, a component provides a particular function or group of related functions for such larger system. The term “component” can also refer to a building block that can be combined with other components in the same or other systems in a distributed network to perform a desired application. The term “component” may refer to elements in a system that are electrically coupled with each other or are capable of electrical communication with each other. A “component” may also be an electrical subsystem, which subsystem is a set of elements. A “component” may also refer to hardware components, software components, services, and/or resources.

As used in this description and in the appended claims, the word “container” does not necessarily refer to a rigid or a somewhat deformable structure, such as a “bottle,” “bottle portion,” or “bottle half” for containing liquid. Rather, the word “container” in the present disclosure and in the appended claims can also mean a “box,” “packet,” “bag,” “portion of a bag,” “pocket of a bag,” or any such deformable structure for containing liquid. The term “container” may refer to a receptacle, such as a carton, can, or jar, in which material is held or carried and/or a large reusable receptacle that can accommodate smaller cartons or cases or chambers. The term “container” may further refer to an object used to hold or store things in and/or a receptacle (as a box or jar or a bottle) for holding goods, such as liquid goods, or non-liquid goods.

The term “bottle” may refer to a receptacle having a narrow neck, usually no handles, and a mouth that can be plugged, corked, or capped and/or a glass or plastic vessel used for storing drinks or other liquids. The term “bottle” may further refer to a container, typically made of glass and having a tapered neck, used for holding liquids and/or a rigid or semi-rigid container typically of glass or plastic having a comparatively narrow neck or mouth and usually no handle. The term “bottle” may further refer to a usually bottle-shaped container made of skin for storing a liquid.

Additionally, the term “bottle” may be synonymous or used interchangeably with the terms: container, flask, decanter, carafe, vessel, canteen, pitcher, vial, and/or jar. This is not an exclusive list, but merely presented as an exemplary illustration.

As used in the present disclosure and in the appended claims, the word “channel” does not necessarily refer to a tunnel, straw, tube, bore, or other such elongated structure for conveying liquid. Rather, the word “channel” in this description and in the appended claims can also refer to an “opening,” or any such structure for conveying liquid. As used in the present disclosure and in the appended claims, the word “chamber” can refer to a cup having an open mouth for drinking or can refer to an enclosed compartment having an opening or orifice for drinking.

The term “replaceable” may refer to putting back into a former position or place and/or to take or fill the place of and/or to be or provide a substitute for. The term “replaceable” can also refer to taking the place of especially as a substitute or successor and/or to take the place of and/or supplant.

The term “removable” may refer to something capable of being removed from a place or released from another object and/or able to be obliterated completely. The term “removable” may also refer to a change in the location, position, station, or residence of something and/or to move by lifting, pushing aside, or taking away or off.

The term “interchangeable” may refer to permitting exchange and/or mutual substitution and/or that can be put or used in place of each other. The term “interchangeable” may also refer to of or relating to or suggestive of complementation and/or capable of replacing or changing places with something else.

The terms “replaceable,” “removable,” and “interchangeable” may be replaced by the terms: equivalent, synonymous, reciprocal, exchangeable, and/or transposable throughout the specification and claims without altering the meaning of the bottle of the present disclosure.

The term “skeleton” and/or “skeleton structure” may refer to any structure created by the skeleton of an organism or object. The terms “skeleton” and/or “skeleton structure” may be replaced by the terms: frame, skeletal frame, chassis, supporting structure, and/or building block without altering the meaning of the bottle of the present disclosure.

The term “attach” and/or “attachable” may refer to fasten, secure, bind, bond, or join and/or to connect as an adjunct or associated condition or part. The term “attach” may also refer to affix or append or add on or supplement or connect or link to or stick on or hook up or clip together. The term “attach” may refer to structural attachments, mechanical attachments and/or electrical attachments of devices/components. The term “coupled to” means to be attached or connected to directly or indirectly or to be incorporated within.

The present disclosure proposes to provide an improved sports bottle. It is a more particular object of the present disclosure to provide an improved sports bottle which is quickly and easily refillable with one or more different liquids, preferably with at least two liquids. It is a still more particular object of the present disclosure to provide an improved sports bottle which is quickly and easily refillable, which effectively prevents the mixture of liquids when dispensed from the bottle by a user, which includes one or more removable/replaceable/interchangeable chambers and/or containers, and which is an environmentally friendly product that manipulates reusable, recyclable, renewable and/or biodegradable materials.

The present disclosure proposes to provide a single or multiple removable compartment pouches/chambers/channels/containers suitable for selectively dispensing one or more different fluids (e.g., different beverages) from the same bottle. Such selective dispensing requires a removable chamber design that allows for manipulation of the removable compartments individually. This allows the consumer to selectively dispense and consume fluids separately, without the possibility of inadvertently mixing the liquids by using one or more removable chambers each containing a desired liquid. The present disclosure also proposes a method for manufacturing a skeleton bottle having one or more removable chambers that prevents the inadvertent mixing of liquids.

Reference will now be made in detail to embodiments of the present disclosure. While certain embodiments of the present disclosure will be described, it will be understood that it is not intended to limit the embodiments of the present disclosure to those described embodiments. To the contrary, reference to embodiments of the present disclosure is intended to cover alternatives, modifications, and equivalents as may be included within the spirit and scope of the embodiments of the present disclosure as defined by the appended claims.

Embodiments will be described below while referencing the accompanying figures. The accompanying figures are merely examples and are not intended to limit the scope of the present disclosure.

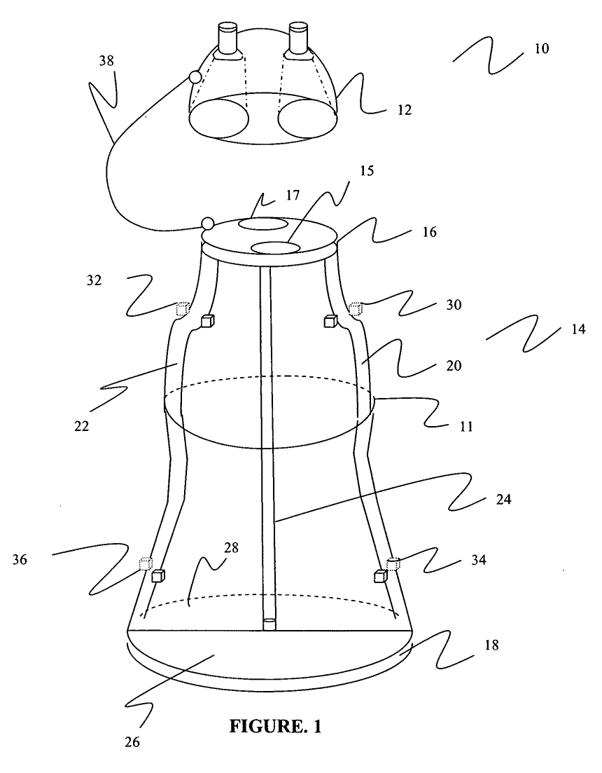

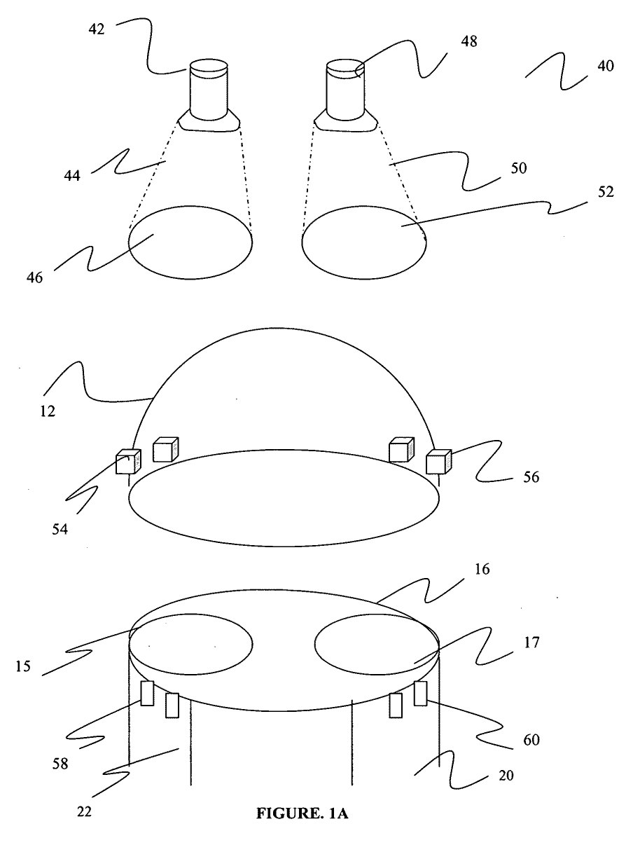

With reference to FIG. 1, there is presented a perspective view of a skeleton structure bottle having a central member and two side members for receiving two removable chambers, each removable chamber containing a different liquid, in accordance with the present disclosure. The skeleton structure bottle 10 includes a removable cap 12, a skeleton body 14, a top portion 16, a base portion 18, a first side member 20, a second side member 22, a central member 24, a first base portion 26, a second base portion 28, a first set of top connection members 30, a second set of top connection members 32, a first set of bottom connection members 34, a second set of bottom connection members 36, and a strap 38. The skeleton structure bottle 10 further includes a first ring 11, a first bottle opening 15, and a second bottle opening 17.

The top portion 16 of the bottle 10 is connected to the base portion 18 via the skeleton body 14. The skeleton body 14 may include a first side member 20, a second side member 22, and a central member 24 for connecting the base portion 18 to the top portion 16. The first side member 20 may be located on an opposing side of the second side member 22. The central member 24 may be an optional member. The first side member 20 and the second side member 22 may be of any suitable shape or size. It will be apparent to those skilled in the art that the diameters and/or heights of the skeleton body 14 may be selected in accordance with design preferences. The skeleton body may also include a plurality of side members of any suitable and/or desirable shape or size.

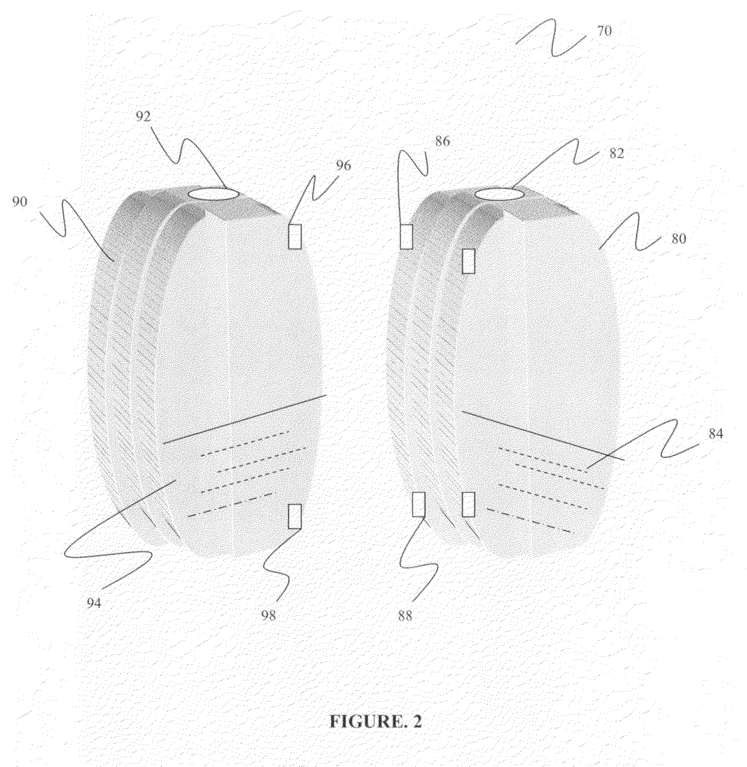

In operation, the user of the skeleton structure bottle 10 can conveniently draw a liquid from the bottle 10 through either the first orifice 42 or the second orifice 48 (see FIG. 1A) of the removable cap 12 (described in detail below with reference to FIG. 1A), while maintaining effective separation of a first liquid 84 contained in a first removable chamber 80 and a second liquid 94 contained in a second removable chamber 90 (see FIG. 2). In other words, the bottle 10 is hollow, reusable, and recyclable. The user may attach, for example, two chambers to the skeleton structure bottle 10, each chamber containing a different liquid. Once the removable chambers are attached to the bottle 10, a user may selectively consume either liquid by using the removable cap 12 having two orifices 42, 48 (see FIG. 2) for respectively connecting to the first bottle opening 15 and the second bottle opening 17 strategically positioned on the top portion 16.

In this embodiment, the first side member 20 and the second side member 22 are non-uniformly curved or irregular members. The top portion 16 of the curved or irregular members 20, 22 may commence at the side of the top portion 16 or may commence on an inner surface portion of the top portion 16. The top portion 16 of the curved members 20, 22 may commence from a common point of the top portion 16 or may commence from different points of the top portion 16. In addition, the first side member 20, the second side member 22, and the central member 24 may all commence from a common point of the top portion 16. For example, the common point may be centrally located on the bottom surface of the top portion 16. It will be apparent to those skilled in the art that the diameters and/or heights and/or dimensions and/or geometrical shapes of the skeleton body 14 may be selected in accordance with preferred or desired design preferences.

Optionally, the removable cap 12 is connected to the skeleton body 14 by means of a strap 38 extending between the removable cap 12 and the top portion 16 of the skeleton body 14. The strap 38 may provide for a permanent connection between the removable cap 12 and the skeleton body 14 so that the two components remain connected to each other at all times.

The first side member 20 and the second side member 22 may each include one or more sets of latching projections (e.g., a first set of top connection members 30, a second set of top connection members 32, a first set of bottom connection members 34, a second set of bottom connection members 36). The latching projections 30, 32, 34, 36 allow the removable chambers 80, 90 (see FIG. 2) to be fixedly secured to the skeleton body 14 of the bottle 10 via the plurality of orientation recesses 86, 88, 96, 98 located on the removable chambers 80, 90 (see FIG. 2).

The latching projections 30, 32, 34, 36 may be spaced out as single units or may be spaced out as sets of two, three, or more. Any number of latching projections 30, 32, 34, 36 may be employed to secure the removable cap 12 to the top portion 16 of the skeleton body 14. The latching projections 30, 32, 34, 36 and the orientation recesses 86, 88, 96, 98 may be any shape or size contemplated by one skilled in the art. Moreover, the latching projections 30, 32, 34, 36 are preferably sufficiently exposed on several strategically placed portions of the skeleton body 14 to facilitate attachment to complementary connection components on a plurality of removable chambers.

The ring 11 is presented merely for illustrative purposes to help the user visualize the hollow bottle. However, it is envisioned that the bottle 10 may be split in such a central location in order to provide for upper removable chambers and lower removable chambers. In other words, one or more removable chambers may be provided directly above the ring 11 and one or more removable chambers may be provided directly below the ring 11. As a result, the removable chambers may be vertical attachable components and/or horizontal attachable components. A first vertical attachable component (e.g., a first removable chamber 80, see FIG. 2) may extend from the first base portion 26 to the first bottle opening 15 of the top portion 16. Also, a second vertical attachable component (e.g., a second removable chamber 90, see FIG. 2) may extend from the second base portion 28 to the second bottle opening 17 of the top portion 16. However, one skilled in the art can envision any type of vertical or horizontal placing configuration for a plurality of removable chambers.

Furthermore, the top portion 16 need not be parallel to the base portion 18. In other words, the top portion 16 may be configured to be at an angle or be an oblique surface with respect to base portion 18. As a result, an oblique cap would be positioned on the oblique top surface of the skeleton structure bottle.

In order to better understand the concept of the present disclosure, the skeleton structure bottle 10 can be thought of in the context of a chassis for automobiles. Automobiles and trucks include a body, the function of which is to contain and protect passengers and their belongings. Bodies are connected to the numerous mechanical, electrical, and structural components that comprise a fully functional vehicle. The body of a vehicle is configured to be positioned on a chassis.

A chassis may consist of a framework that supports an inanimate object, analogous to an animal's skeleton, for example in a motor vehicle. Some vehicle manufacturers have contemplated designing a universal chassis that fits several different bodies of automobiles. As a result, the amount of time and resources required to design and manufacture new vehicle bodies are reduced due to the availability of a common universal chassis. Thus, body designs need only conform to the simple attachment interface of the chassis, eliminating the need to redesign or reconfigure expensive components. Also, vehicle owners can increase the functionality of their vehicles at a lower cost than possible with the conventional systems because a vehicle owner need buy only one chassis upon which to mount a multitude of body styles. The body enclosure may include a body skeleton structure having body openings formed therein, each of which is covered by one or more panels.

Similarly, as in automobile manufacturing of a common skeleton chassis or framework, the present disclosure contemplates using a framework or skeleton structure for a drinking bottle. Instead of attaching panels to automobiles, the present disclosure contemplates attaching removable chambers containing multiple liquids to a skeleton bottle. The skeleton body-attachment interface of the claimed disclosure enables compatibility between a skeleton “chassis” (i.e., skeleton bottle) and different types of bodies (i.e., removable liquid chambers) having substantially different designs.

Stated in a different way, a spatial relationship is defined between a skeleton bottle and a plurality of removable chambers. In the same predetermined spatial relationship with one another as the predetermined spatial relationship between body connection components on the body-attachment interface of a vehicle, the plurality of removable chambers are each matable with the chassis or skeleton bottle by positioning the removable chambers relative to the chassis or the skeleton bottle.

Moreover, in a conventional manufacturing process, plastic bottles are manufactured as a single unitary system. According to the present disclosure, the skeleton bottle system is manufactured independently of the removable liquid chambers. The removable liquid chambers, which contain the different liquids, may be manufactured by a plurality of liquid producing manufacturers located around the world. The removable liquid chambers may be manufactured and designed substantially independently anywhere in the world to meet different consumer desires. Local manufacturers, using locally available materials, can build removable liquid chambers containing liquids according to local tastes. However, the skeleton structure remains the same no matter what removable liquid chamber is attached to the skeleton body. As a result, designers have the ability to redesign liquid chambers without reengineering the entire bottle.

In addition, by using the same skeleton structure bottle 10, less plastic is used in the manufacture of bottles. When compared to other materials like glass and metal materials, plastic polymers require greater processing to be recycled. Plastics have a low entropy of mixing, which is due to the high molecular weight of their large polymer chains. A macromolecule interacts with its environment along its entire length, so its enthalpy of mixing is large compared to that of an organic molecule with a similar structure.

Another barrier to recycling is the widespread use of dyes, fillers, and other additives in plastics. The polymer is generally too viscous to economically remove fillers, and would be damaged by many of the processes that could cheaply remove the added dyes. Additives are less widely used in beverage containers and plastic bags, allowing them to be recycled more frequently. Low national plastic recycling rates have been due to the complexity of sorting and processing, unfavorable economics, and consumer confusion about which plastics can actually be recycled.

Thus, plastic recycling is a complex and time-consuming process, which could be significantly reduced by the concept of the present disclosure. It is envisioned that the removable chambers be manufactured by biodegradable polymers or any other type or biodegradable material. By manufacturing only the removable chambers, the amount of plastic manufactured and/or processed is significantly reduced.

It will be apparent to those skilled in the art that this separation of liquids via a renewable, reusable, and/or recyclable skeleton structure bottle 10 offers a substantial advantage by providing the capability to drink more than one liquid without inadvertently mixing a plurality of liquids and simultaneously being environmentally-conscious by consuming less plastic materials.

With reference to FIG. 1A, there is a presented an exploded view of the skeleton structure of FIG. 1 having a removable cap with two fixed orifices, in accordance with the present disclosure. The exploded view 40 of the removable cap 12 includes a first orifice 42, a first connecting member 44, a first cap opening 46, a second orifice 48, a second connecting member 50, a second cap opening 52, a first set of projections 54, a second set of projections 56, a first set of orientation recesses 58, and a second set of orientation recesses 60. FIG. 1A includes similar elements as FIG. 1. Such similar elements include the removable cap 12, the first bottle opening 15, the second bottle opening 17, and the top portion 16.

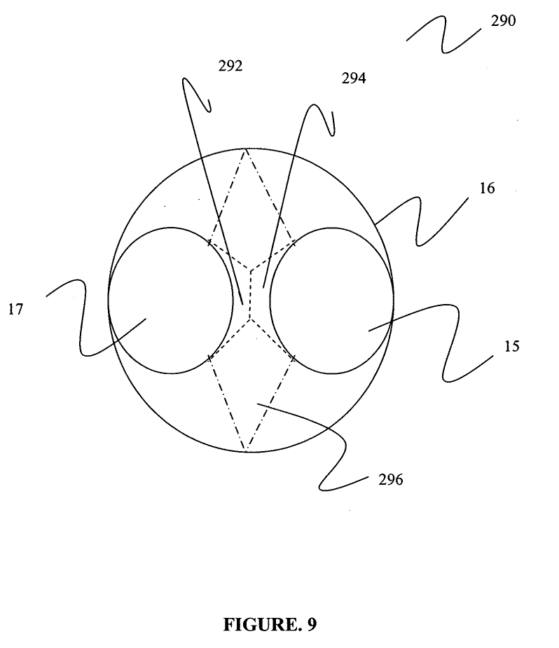

In operation, the first orifice 42 would be placed in the mouth of a user, who would squeeze the bottle 10 (see FIG. 1) to eject a first liquid 84 from a first removable chamber 80 (see FIG. 2). Alternately, the second orifice 48 would be placed in the mouth of a user, who would squeeze the bottle 10 (see FIG. 1) to eject a second liquid 94 from the second removable chamber 90 (see FIG. 2). In operation, a gap portion 296 would separate the upper portions of each removable chamber 80, 90 in order to prevent the inadvertent mixture of liquids. Alternately, in operation a gap portion 296 would separate the lower portion of the cap openings of the removable cap 12 in order to prevent the inadvertent mixture of liquids. The gap portion 296 will be described in detail with reference to FIG. 9 described below.

The exploded view 40 of the skeleton structure bottle 10 described in FIG. 1A merely illustrates how the first orifice configuration (42, 44, 46) and the second orifice configuration (48, 50, 52) connect to the dome-shaped removable cap 12 that includes a plurality of latching projections 54, 56, which in turn connect to a plurality of orientation recesses 58, 60 of the skeleton body 14 (see FIG. 1). The first orifice configuration (42, 44, 46) and the second orifice configuration (48, 50, 52) are fixedly secured within the dome-shaped removable cap 12 in order to provide a user of skeleton structure bottle 10 with the ability to selectively drink from either the first orifice 42 or the second orifice 48.

The dome-shaped removable cap 12 can be any reasonable and/or suitable size for securedly fitting onto the skeleton body 14 of the bottle 10 of FIG. 1. The first cap position opening 46 is designed to be fixedly secured to the first chamber opening 82 (see FIG. 2), whereas the second cap position 52 is designed to be fixedly secured to the second chamber opening 92 (see FIG. 2). The removable cap 12 can be fixedly secured to the skeleton body 14 in only two ways in order to properly be affixed. In other words, the first cap position opening 46 and the second cap position opening 52 are designed to coincide with either the first chamber opening 82 and/or the second chamber opening 92 of the removable chambers 80, 90 (see FIG. 2). Thus, the removable cap 12 is fixedly secured to the top portion 16 of the bottle 10 in only two ways.

The removable cap 12 is releasably coupled to the top portion 16 of the skeleton structure bottle 10. The shape and dimensions of the removable cap 12 may be adapted to those of the skeleton body 14 such that the removable cap 12 can be placed onto the skeleton body 14 for repeatedly sealing the first removable chamber 80 and the second removable chamber 90 (see FIG. 2). The removable cap 12 may be coupled to the top portion 16 of the skeleton body 14 by using any suitable fastening mechanism, such as a threaded fastening mechanism or a snap-fit fastening mechanism.

Furthermore, the first orifice 42 may be a different design than the second orifice 48. For example, the first orifice 42 may be a straw configuration, whereas the second orifice 48 may be a cap configuration. Of course, one skilled in the art can contemplate any combination of different types of orifices that are reasonable and/or suitable to such skeleton structure bottle 10 (see FIG. 1).

With reference to FIG. 2, there is presented a perspective view of dual chambers configured to be securedly fixed to the skeleton structure bottle of FIG. 1, in accordance with the present disclosure. The dual removable chambers 70 include a first removable chamber 80, a first chamber opening 82, a first liquid 84, a first set of upper connecting members 86, and a first set of lower connecting members 88. The dual removable chambers 70 further include a second removable chamber 90, a second chamber opening 92, a second liquid 94, a second set of upper connecting members 96, and a second set of lower connecting members 98.

The first removable chamber 80 includes a first chamber opening 82 at the top portion of the first removable chamber 80 for inserting a first liquid 84. The first removable chamber 80 further includes a first set of upper connecting members 86 and a first set of lower connecting members 88 for connecting the removable chamber 80 to a skeleton structure bottle 10 of FIG. 1.

The second removable chamber 90 includes a second chamber opening 92 at the top portion of the second removable chamber 90 for inserting a second liquid 94. The second removable chamber 90 further includes a second set of upper connecting members 96 and a second set of lower connecting members 98 for connecting the removable chamber 90 to a skeleton structure bottle 10 of FIG. 1.

The first removable chamber 80 and the second removable chamber 90 may be of any suitable shape or size (height or diameter) in accordance with the desired application. The first chamber opening 82 may be strategically positioned in any location on either the top portion or a side portion of the first removable chamber 80. The second chamber opening 92 may be strategically positioned in any location on either the top portion or a side portion of the second removable chamber 90. The first chamber opening 82 and the second chamber opening 92 need not be centrally located on the top portion of the removable chambers 80, 90, respectively. The first removable chamber 80 and the second removable chamber 90 are designed to be fixedly secured into the skeleton body 14 of the skeleton structure bottle 10 (see FIG. 1). A plurality of removable chambers may be fixedly secured either in a horizontal or a vertical configuration within the skeleton structure 14 of the skeleton structure bottle 10.

The skeleton structure bottle 10 (see FIG. 1) illustrates that the removable chambers 80, 90 (see FIG. 2) are of the same volumetric size. However, it is contemplated that the removable chambers 80, 90 can be of different volumetric sizes. In other words, the first chamber 80 may be smaller than the second chamber 90 (or vice versa). The volumetric size of each removable chamber 80, 90 may be determined by one or more desired applications. In addition, the height of the first removable chamber 80 and the second removable chamber 90 is approximately the same in FIG. 1. However, it is contemplated that the height of the first removable chamber 80 and the second removable chamber 90 can be of a different size.

The first removable chamber 80 and the second removable chamber 90 may each include one or more sets of latching projections (e.g., a first set of upper connecting members 86, a first set of lower connecting members 88, a second set of upper connecting members 96, and a second set of lower connecting members 98). These latching projections 86, 88, 96, 98 allow the removable chambers 80, 90 to be fixedly secured to the skeleton body 14 of the skeleton structure bottle 10 (see FIG. 1) via the plurality of orientation recesses located on the skeleton body 14.

The latching projections 86, 88, 96, 98 may be spaced out as single units or may be spaced out as sets of two, three, or more. Any number of latching projections 86, 88, 96, 98 may be employed to secure the removable chambers 80, 90 to the skeleton body 14. The latching projections 86, 88, 96, 98 and the orientation recesses may be any shape or size contemplated by one skilled in the art. The latching projections 86, 88, 96, 98 and the orientation recesses may be strategically positioned on any portion of the skeleton body 14 and/or the removable chambers 80, 90 for providing the best desired connection/attachment mechanisms. In addition, latching projection configurations and orientation recesses may be freely interchangeable on the skeleton body 14 and/or the removable chambers 80, 90.

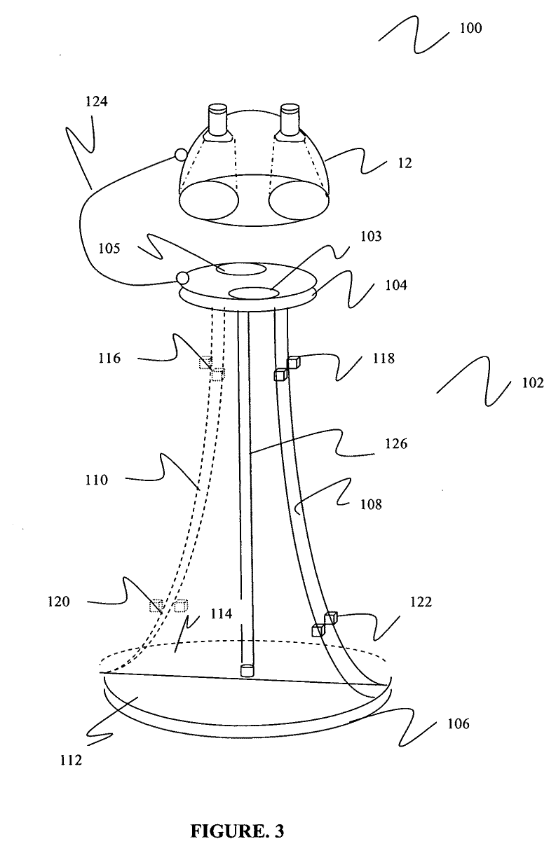

With reference to FIG. 3, there is presented a perspective view of a skeleton structure bottle having a central member and two side members for receiving two removable chambers, each removable chamber containing a different liquid and each side member being an inwardly curved structure, in accordance with the present disclosure. The skeleton structure bottle 100 includes a skeleton body 102, a top portion 104, a bottom portion 106, a first side member 108, a second side member 110, a first base portion 112, a second base portion 114, a first set of top connection members 116, a second set of top connection members 118, a first set of bottom connection members 120, a second set of bottom connection members 122, a strap 124, and a central member 126. The skeleton structure bottle 100 further includes a first bottle opening 103 and a second bottle opening 105. FIG. 3 includes similar elements as FIG. 1. Such similar elements include the removable cap 12.

FIG. 3 is similar to FIG. 1. However, FIG. 3 illustrates that the first side member 108 and the second side member 110 are different than the side members 20, 22 presented in FIG. 1. For instance, the top portion 104 is connected to the bottom portion 106 via the skeleton body 102. The skeleton body 102 may include a first side member 108, a second side member 110, and a central member 126 for connecting the bottom portion 106 to the top portion 104. The first side member 108 may be located on an opposing side of the second side member 110. The central member 126 may be an optional member.

The first side member 108 and the second side member 110 may be of any suitable shape or size. In this embodiment, the first side member 108 and the second side member 110 are inwardly curved members. The top portion of the inwardly curved members 108, 110 may commence at the side of the top portion 104 or may commence on an inner surface portion of the top portion 104. The top portion 104 of the inwardly curved members 108, 110 may commence from a common point of the top portion 104 or may commence from different points of the top portion 104. In addition, the first side member 108, the second side member 110, and the central member 126 may all commence from a common point of the top portion 104. For example, the common point may be centrally located on the bottom surface of the top portion 104. It will be apparent to those skilled in the art that the diameters and/or heights of the skeleton body 102 may be selected in accordance with design preferences.

The first side member 108 and the second side member 110 may each include one or more sets of latching projections (e.g., a first set of top connection members 116, a second set of top connection members 118, a first set of bottom connection members 120, and a second set of bottom connection members 122). The latching projections 116, 118, 120, 122 allow the removable chambers 80, 90 (see FIG. 2) to be fixedly secured to the skeleton body 102 of the bottle 100 via the plurality of orientation recesses located on the removable chambers 80, 90.

The latching projections 116, 118, 120, 122 may be spaced out as single units or may be spaced out as sets of two, three, or more. Any number of latching projections 116, 118, 120, 122 may be employed to secure the removable cap 12 to the skeleton body 102. The latching projections 116, 118, 120, 122 and the orientation recesses may be any shape or size contemplated by one skilled in the art. Moreover, the latching projections 116, 118, 120, 122 are preferably sufficiently exposed on several strategically placed portions of the skeleton body 102 to facilitate attachment to complementary connection components on a plurality of removable chambers. In addition, latching projection configurations and orientation recesses may be freely interchangeable on the skeleton body 102 and/or the removable chambers 80, 90.

Once again, a user may attach, for example, two chambers to the skeleton structure bottle 100, each chamber containing a different liquid. Once the chambers are attached to the bottle 100, a user may selectively consume either liquid by using the removable cap 12 having two orifices 42, 48 (see FIG. 2) for respectively connecting to the first bottle opening 103 and the second bottle opening 105 strategically positioned on the top portion 104.

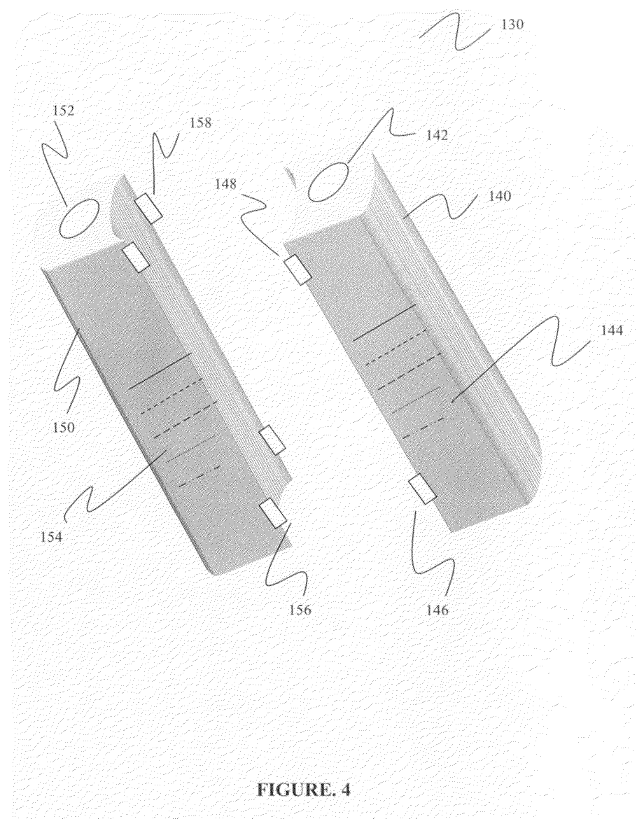

Furthermore, the removable chambers may be vertical attachable components and/or horizontal attachable components. A first vertical attachable component (e.g., a first removable chamber 140, see FIG. 4) may extend from the first base portion 112 to the first bottle opening 103 of the top portion 104. Also, a second vertical attachable component (e.g., a second removable chamber 150, see FIG. 4) may extend from the second base portion 116 to the second bottle opening 105 of the top portion 104. However, one skilled in the art can envision any type of vertical or horizontal placing configuration for the removable chambers.

Optionally, the removable cap 12 is connected to the skeleton body 102 by means of a strap 124 extending between the removable cap 12 and the top portion 104 of the skeleton body 102. The strap 124 may provide for a permanent connection between the removable cap 12 and the skeleton body 102 so that the two components remain connected to each other at all times.

It will be apparent to those skilled in the art that this separation of liquids via a renewable, reusable, and/or recyclable skeleton structure bottle 100 offers a substantial advantage by providing the capability to drink more than one liquid without inadvertently mixing a plurality of liquids and simultaneously being environmentally-conscious by consuming less plastic materials.

With reference to FIG. 4, there is presented a perspective view of dual chambers configured to be securedly fixed to the skeleton structure bottle of FIG. 3, in accordance with the present disclosure. The dual removable chambers 130 include a first removable chamber 140, a first chamber opening 142, a first liquid 144, a first set of upper connecting members 146, and a first set of lower connecting members 148. The dual removable chambers 130 further include a second removable chamber 150, a second chamber opening 152, a second liquid 154, a second set of upper connecting members 156, and a second set of lower connecting members 158.

The first removable chamber 140 includes a first chamber opening 142 at the top portion of the first removable chamber 140 for inserting a first liquid 144. The first removable chamber 140 further includes a first set of lower connecting members 146 and a first set of upper connecting members 148 for connecting the removable chamber 140 to a skeleton structure bottle 100 of FIG. 3.

The second removable chamber 150 includes a second chamber opening 152 at the top portion of the second removable chamber 150 for inserting a second liquid 154. The second removable chamber 150 further includes a second set of lower connecting members 156 and a second set of upper connecting members 158 for connecting the removable chamber 150 to a skeleton structure bottle 100 of FIG. 3.

The first removable chamber 140 and the second removable chamber 150 may be of any suitable shape or size (height or diameter) in accordance with the desired application. The first chamber opening 142 may be strategically positioned in any location on either the top portion or a side portion of the first removable chamber 140. The second chamber opening 152 may be strategically positioned in any location on either the top portion or a side portion of the second removable chamber 150. The first chamber opening 142 and the second chamber opening 152 need not be centrally located on the top portion of the removable chambers 140, 150, respectively. The first removable chamber 140 and the second removable chamber 150 are designed to be fixedly secured into the skeleton body 102 of the skeleton structure bottle 100 (see FIG. 3). A plurality of removable chambers may be fixedly secured either in a horizontal or a vertical configuration within the skeleton structure 102 of the skeleton structure bottle 100.

The bottle 100 (see FIG. 3) illustrates that the removable chambers 140, 150 are of the same volumetric size. However, it is contemplated that the removable chambers 140, 150 can be of different volumetric sizes. In other words, the first chamber 140 may be smaller than the second chamber 150 (or vice versa). The volumetric size of each removable chamber 140, 150 may be determined by one or more desired applications. In addition, the height of the first removable chamber 140 and the second removable chamber 150 is approximately the same in FIG. 3. However, it is contemplated that the height of the first removable chamber 140 and the second removable chamber 150 can be of a different size.

The first removable chamber 140 and the second removable chamber 150 may each include one or more sets of latching projections (e.g., a first set of lower connecting members 146, a first set of upper connecting members 148, a second set of lower connecting members 156, and a second set of upper connecting members 158). These latching projections 146, 148, 156, 158 allow the removable chambers 140, 150 to be fixedly secured to the skeleton body 102 of the bottle 100 (see FIG. 3) via the plurality of orientation recesses located on the skeleton body 102.

The latching projections 146, 148, 156, 158 may be spaced out as single units or may be spaced out as sets of two, three, or more. Any number of latching projections 146, 148, 156, 158 may be employed to secure the removable chambers 140, 150 to the skeleton body 102. The latching projections 146, 148, 156, 158 and the orientation recesses may be any shape or size contemplated by one skilled in the art. The latching projections 146, 148, 156, 158 and the orientation recesses may be strategically positioned on any portion of the skeleton body 102 and/or the removable chambers 140, 150 for providing the best desired connection/attachment mechanisms. In addition, latching projection configurations and orientation recesses may be freely interchangeable on the skeleton body 102 and/or the removable chambers 140, 150.

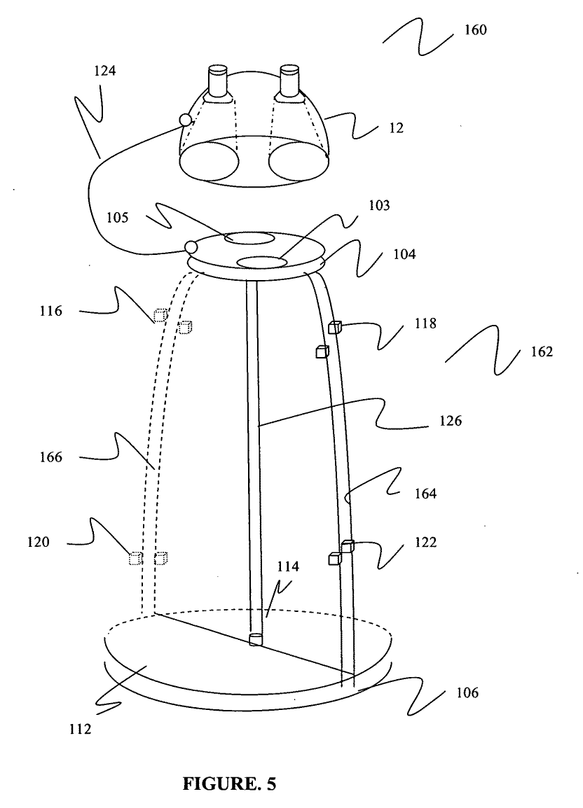

With reference to FIG. 5, there is presented a perspective view of a skeleton structure bottle having a central member and two side members for receiving two removable chambers, each removable chamber containing a different liquid and each side member being an outwardly curved structure, in accordance with the present disclosure. The skeleton structure bottle 160 includes a skeleton body 162, a first curved side member 164, and a second curved side member 166. FIG. 5 includes similar elements as FIG. 3. Such similar elements include the removable cap 12, a top portion 104, a bottom portion 106, a first base portion 112, a second base portion 114, a first set of top connection members 116, a second set of top connection members 118, a first set of bottom connection members 120, a second set of bottom connection members 122, a central member 126, a first bottle opening 103, and a second bottle opening 105.

FIG. 5 is similar to FIG. 3. However, FIG. 5 illustrates that the first curved side member 164 and the second curved side member 166 are different than the side members 20, 22 presented in FIG. 1 or the side members 108, 110 presented in FIG. 3. For instance, the top portion 104 is connected to the bottom portion 106 via the skeleton body 162. The skeleton body 162 may include a first side member 164, a second side member 166, and a central member 126 for connecting the bottom portion 106 to the top portion 104. The first side member 164 may be located on an opposing side of the second side member 166. The central member 126 may be an optional member.

The first side member 164 and the second side member 166 may be of any suitable shape or size. In this embodiment, the first side member 164 and the second side member 166 are outwardly curved members. The top portion of the outwardly curved members 164, 166 may commence at the side of the top portion 104 or may commence on an inner surface portion of the top portion 104. The top portion 104 of the outwardly curved members 164, 166 may commence from a common point of the top portion 104 or may commence from different points of the top portion 104. In addition, the first side member 164, the second side member 166, and the central member 126 may all commence from a common point of the top portion 104. For example, the common point may be centrally located on the bottom surface of the top portion 104. It will be apparent to those skilled in the art that the diameters and/or heights of the skeleton body 162 may be selected in accordance with design preferences.

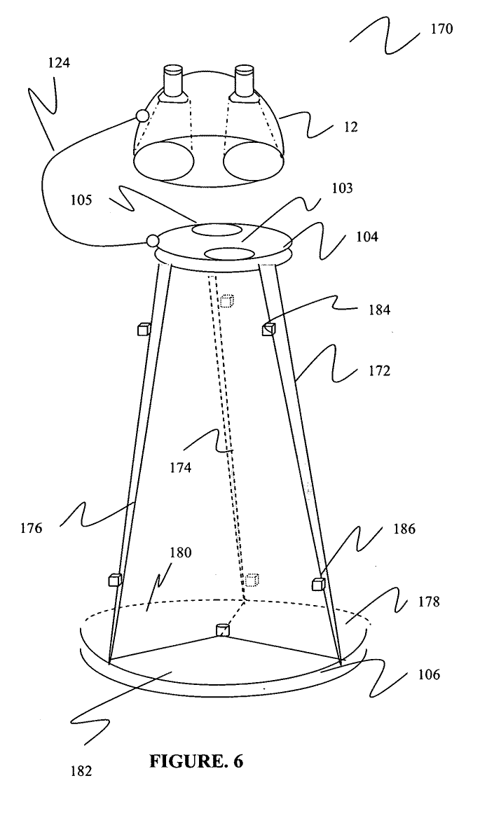

With reference to FIG. 6, there is presented a perspective view of a skeleton structure bottle having a central member and three side members for receiving three removable chambers, each removable chamber containing a different liquid, in accordance with the present disclosure. The skeleton structure bottle 170 includes a first side member 172, a second side member 174, a third side member 176, a first base portion 178, a second base portion 180, a third base portion 182, a first set of connecting members 184, and a second set of connecting members 186. FIG. 6 includes similar elements as FIG. 3. Such similar elements include the removable cap 12, a top portion 104, a bottom portion 106, a first bottle opening 103, and a second bottle opening 105.

The top portion 104 of the bottle 170 is connected to the base portion 106 via the skeleton body configuration (172, 174, 176). The skeleton body configuration (172, 174, 176) may include a first side member 172, a second side member 174, a third side member 176, and a central member 126 (shown in FIGS. 1, 3) for connecting the base portion 106 to the top portion 104. The central member 126 may be an optional member. The first side member 172, the second side member 174, and the third side member 176 may be of any suitable shape or size. It will be apparent to those skilled in the art that the diameters and/or heights of the skeleton body configuration (172, 174, 176) may be selected in accordance with design preferences.

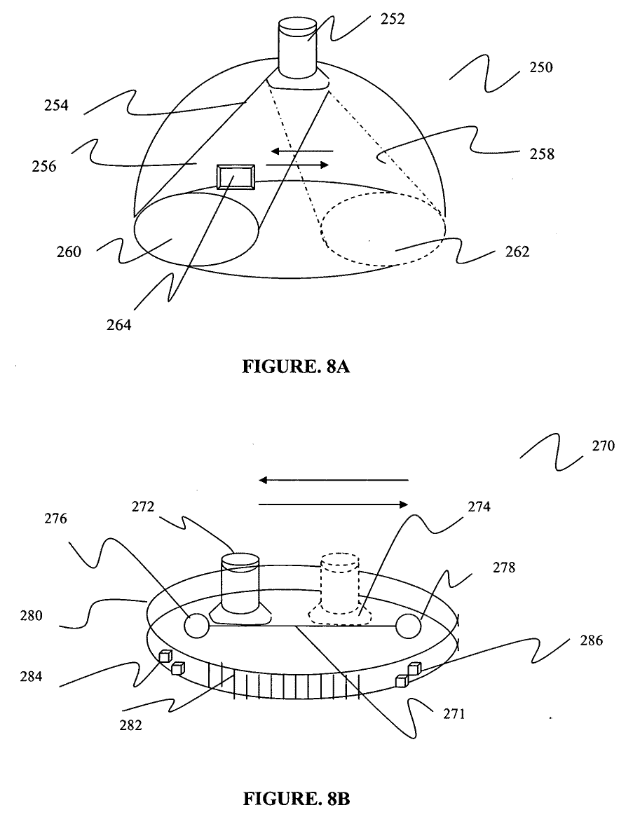

In operation, the bottle 170 is hollow, reusable, and recyclable. The user may attach, for example, three chambers to the skeleton structure bottle 170, each chamber containing a different liquid. Once the chambers are attached to the bottle 170, a user may selectively consume any liquid by using a removable cap (see FIGS. 8A, 8B) having one fixed orifice for connecting to each removable chamber.

In this embodiment, the first side member 172, the second side member 174, and the third side member 176 are straight members. However, such side members 172, 174, 176 may be curved, non-linear or irregular. The top portion 104 of the side members 172, 174, 176 may commence at the side of the top portion 104 or may commence on an inner surface portion of the top portion 104. The top portion 104 of the curved members 172, 174, 176 may commence from a common point of the top portion 104 or may commence from different points of the top portion 104. In addition, the side members 172, 174, 176, and the central member 126 may all commence from a common point of the top portion 104. For example, the common point may be centrally located on the bottom surface of the top portion 104. It will be apparent to those skilled in the art that the diameters and/or heights and/or dimensions and/or geometrical shape of the skeleton body configuration (172, 174, 176) may be selected in accordance with preferred or desired design preferences.

Removable chambers may be vertically attachable components and/or horizontally attachable components. A first vertical attachable component may extend from the first base portion 178 to a first bottle opening of the top portion of a skeleton structure. A second vertical attachable component may extend from the second base portion 180 to a second bottle opening of a top portion of a skeleton structure. A third vertical attachable component may extend from the third base portion 182 to a third bottle opening of a top portion of a skeleton structure. One skilled in the art can envision any type of vertical or horizontal placing configuration for a plurality of removable chambers connected to a variety of different removable caps having fixed or slidable orifices.

The three removable chambers may each include one or more sets of latching projections (e.g., a first set of connecting members 184 and a second set of connecting members 186). These latching projections 184, 186 allow the three removable chambers to be fixedly secured to any skeleton body contemplated by one skilled in the art.

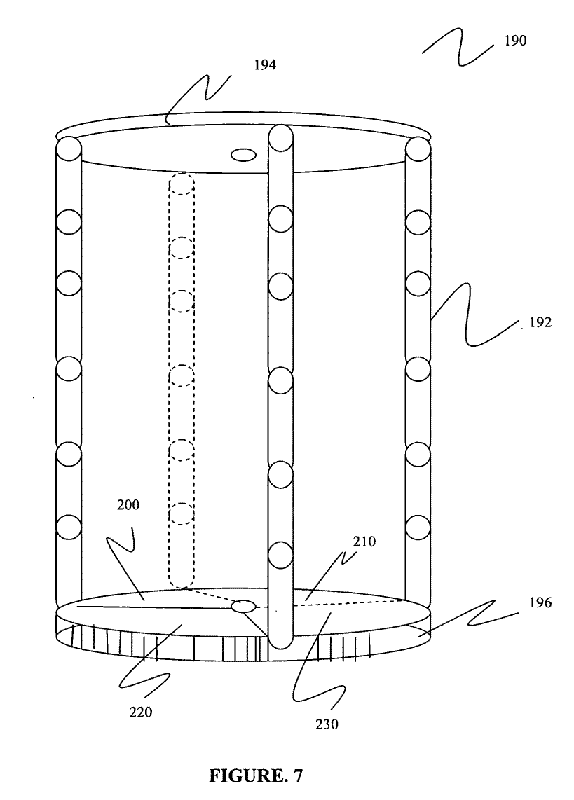

With reference to FIG. 7, there is presented a perspective view of a skeleton structure bottle having four side members for receiving four removable chambers, each removable chamber containing a different liquid, in accordance with the second embodiment of the present disclosure. The skeleton structure bottle 190 includes a plurality of side members 192, a top portion 194, a bottom portion 196, a first base portion 200, a second base portion 210, a third base portion 220, and a fourth base portion 230.

The top portion 194 of the bottle 190 is connected to the base portion 196 via the plurality of side members 192 configured to compose a skeleton body configuration. The plurality of side members 192 may include four side members for connecting the base portion 196 to the top portion 194. The plurality of side members 192 may be of any suitable shape or size. The plurality of side members may be strategically positioned or connected to any part of the inner surfaces of the top portion 194 and/or the base portion 196 (as discussed above with reference to FIGS. 1 and 3).

In operation, the bottle 190 is hollow, reusable, and recyclable. The user may attach, for example, four chambers to the skeleton structure bottle 190, each chamber containing a different liquid. The chambers may be positioned in a first base portion 200, a second base portion 210, a third base portion 220, and a fourth base portion 230, respectively. Once the chambers are attached to the bottle 190, a user may selectively consume any liquid by using a removable cap (see FIGS. 8A, 8B) having one fixed orifice for connecting to each removable chamber.

FIG. 7 merely illustrates that a plurality of side members 192 may be attached between the top portion 194 and the bottom portion 196. FIG. 7 also illustrates that the top portion 194 may be composed of a plurality of bottle openings for accessing one or more orifices of a removable cap. FIG. 7 further illustrates that the skeleton structure or framework or chassis of the bottle may be any design contemplated by one skilled in the art.

Additionally, it is contemplated that no side members are attached between the top portion and the bottom portion of a skeleton bottle. The skeleton bottle may merely be composed of a single central member extending from the base portion to the top portion. As a result, a single removable chamber may be attachable in such a configuration. It is envisioned that such removable chamber wraps around or engulfs the central member. The single removable chamber may be made of a flexible material holding a single liquid. Of course, it is contemplated that all the removable chambers of the present disclosure may be made of flexible biodegradable materials for easily attaching to any type of skeleton structure.

With reference to FIG. 8A, there is presented a perspective view of a removable cap having a fixed switchable orifice connected to the skeleton structure bottle of FIG. 1, in accordance with the present disclosure. The removable cap 250 includes an orifice 252, a connecting member 254, a first connecting position 256, a second connecting position 258, a first position cap opening 260, a second position cap opening 262, and a switch 264.

In the second embodiment of the removable cap 250, the removable cap 250 is releasably coupled to the top portion 16 of the bottle 10 (see FIG. 1) or any of the other bottles presented in this disclosure. The shape and dimensions of the removable cap 250 may be adapted to those of the skeleton body 14 such that the removable cap 250 can be placed onto the top portion 16 of the skeleton body 14 for repeatedly sealing the first chamber 80 and the second chamber 90 (see FIG. 2). The removable cap 250 may be coupled to the top portion 16 by using any suitable fastening mechanism, such as a threaded fastening mechanism or a snap-fit fastening mechanism.

The removable cap 250 is molded into a dome shape including a single orifice 252. The orifice 252 is attached to a single connecting member 254 that extends through the dome-shape of the cap 250 up to a cap opening (260 or 262). The connecting member 254 can be moved from a first connecting position 256 of the connecting member 254 to a second connecting position 258 of the connecting member 254. The first connecting position 256 of the connecting member 254 ends at a first cap position opening 260 and the second connecting position 258 of the connecting member 254 ends at a second cap position opening 262.

A switch 264 enables the connecting member 254 to move between the first connecting position 256 and the second connecting position 258. The switch 264 may be mounted and/or located and/or positioned on any part of the surface of the dome-shaped removable cap 250. Preferably, the switch 264 is located on the lower edge of the bottom portion of the dome-shaped removable cap 250.

The dome-shaped cap 250 can be any reasonable and/or suitable size for securedly fitting onto the top portion 16 of skeleton body 14 of the bottle 10 (see FIG. 1) or any of the other bottle configurations described herein. The first cap position opening 260 is designed to be fixedly secured to the first bottle opening 15, whereas the second cap position 262 is designed to be fixedly secured to the second bottle opening 17 (see FIG. 1). The removable cap 250 can be fixedly secured to the top portion 16 of the skeleton body 14 in only two ways in order to properly be affixed. In other words, the first cap position opening 260 and the second cap position opening 262 are designed to coincide with the first bottle opening 15 and the second bottle opening 17, respectively.

The orifice 252 remains in a fixed position on the dome-shaped removable cap 250. However, the connecting member 254 shifts between two positions (i.e., between cap opening 260 and cap opening 262) in order to allow individual and separate access to the first bottle opening 15 and the second bottle opening 17 (see FIG. 1). This configuration, as all other configurations of the present disclosure, in combination with the gap portion 296 (see FIG. 9), prevents the inadvertent mixture of liquids 84, 94 (see FIG. 2).

With reference to FIG. 8B, there is presented a perspective view of a removable cap having a fixed slidable orifice connected to the skeleton structure bottle of FIG. 1, in accordance with the present disclosure. The removable cap 270 includes a first orifice position 272, a second orifice position 274, a first connection point 276, a second connection point 278, a top portion 280, an annular skirt 282, a first set of projections 284, and a second set of projections 286. The removable cap 270 further includes a slidable track 271.

The removable cap 270 is releasably coupled to the top portion 16 of the bottle 10 (see FIG. 1) or any other bottle configuration disclosed herein. The shape and dimensions of the removable cap 270 may be adapted to those of the skeleton body 14 such that the removable cap 270 can be placed onto the top portion 16 of the body skeleton 14 for repeatedly sealing the first chamber 80 and the second chamber 90 (see FIG. 2). The removable cap 270 may be coupled to the top portion 16 of the skeleton body 14 by using any suitable fastening mechanism, such as a threaded fastening mechanism or a snap-fit fastening mechanism.

The removable cap 270 includes an orifice 272 which is slidably movable across the surface 280 of the removable cap 270. The orifice 272 can slidably move between the first connection portion 276 and the second connection portion 278. A clicking or snapping mechanism may be engaged to secure the orifice 272 to either the first connection portion 276 or the second connection portion 278. The first connection portion 276 and the second connection portion 278 are fixed points on the removable cap 270.

The orifice 272 may slidably move between the first connection portion 276 and the second connection portion 278 by means of or via the slidable track 271. The slidable track 271 ensures that the orifice 272 moves in a predetermined or pre-designated path along the surface 280 of the removable cap 270. For example, the orifice 272 may move to a second orifice position 274. The slidable function allows the user of the bottle 10 to readily switch between the first chamber 80 and the second chamber 90 to selectively access either the first liquid 84 or the second liquid 94 (see FIG. 2). The arrows indicate that the orifice 272 can move in a horizontal direction on the surface 280. However, it is contemplated that the path may not be a linear path. The path may be a circular path or a zigzag path or any other type of path that may be contemplated for moving the orifice 272 over the surface 280 of removable cap 270.

Additionally, the annular skirt 282 may include one or more sets of a first latching projection 284 and a second latching projection 286. These latching projections 284, 286 allow the removable cap 270 to be fixedly secured to the top portion 16 of the skeleton body 14 of the bottle 10 (see FIG. 1) via a plurality of orientations recesses. The latching projections 284, 286 may be spaced out as single units or may be spaced out as sets of two, three, or more. Any number of latching projections 284, 286 may be employed to secure the removable cap 270 to the top portion 16 of the skeleton body 14 (see FIG. 1). The latching projections 284, 286 and the orientation recesses may be any shape or size contemplated by one skilled in the art. In addition, latching projection configurations and orientation recesses may be freely interchangeable on the skeleton body 14 and/or the removable chambers 80, 90 (see FIGS. 1, 2).

With reference to FIG. 9, there is presented a top view of the top portion of the skeleton structure of FIG. 1 illustrating the gap portion for preventing the inadvertent mixture of liquids, in accordance with the present disclosure. The top view 290 includes a first ridge 292, a second ridge 294, and a gap portion 296. FIG. 9 includes similar elements as FIG. 1. Such similar elements include the first bottle opening 15, the second bottle opening 17, and the top portion 16.

The gap portion 296 provides for the effective separation of the first liquid 84 contained in the first removable chamber 80 from the second liquid 94 contained in the second removable chamber 90 (see FIG. 2). It is envisioned that the gap portion 296 may be of any reasonable and/or suitable vertical or horizontal length and may be adapted to conform to the height of the first removable chamber 80 and/or the second removable chamber 90 (see FIG. 2).

The gap portion 296 prevents the fluid communication between the first removable chamber 80 and the second removable chamber 90. The gap portion 296 allows for (i) fluid communication between the first removable chamber 80 and the first orifice 42 and (ii) fluid communication between the second removable chamber 90 and the second orifice 48 (see FIGS. 1A, 2). The gap portion 296 does not allow fluid communication between the first orifice 42 and the second removable chamber 90, nor between the second orifice 48 and the first removable chamber 80.

The gap portion 296 allows for two separate bottle necks (not shown) for preventing the mixing of the first liquid 84 and the second liquid 94 located in the first removable chamber 80 and the second removable chamber 90, respectively (see FIG. 2). The gap portion 296 does not permit the bottle necks to come into contact with each other in order to prevent first liquid 84 from coming into contact with the second liquid 94.

As a result of the gap portion 296, the upper portion of the first removable chamber 80 has a smaller width than the lower portion of the first removable chamber 80. In addition, as a result of the gap portion 296, the upper portion of the second removable chamber 90 has a smaller width than the lower portion of the second removable chamber 90. The gap portion 296 allows for the height of the central member 24 (dividing member) to be less than the overall height of the skeleton body 14. Also, the connecting point of the first ridge 292 and the second ridge 294 is configured to be a maximum height of the central member 24.

It is envisioned that the gap portion 296 may be incorporated with the removable chambers. However, it is also envisioned that the gap portion 296 may be incorporated with the removable cap. Moreover, it is envisioned that the gap portion is a separate component/element/device that connects a removable cap to a skeleton structure having one or more removable chambers.

It is envisioned that the top portion 16 (the rim of the skeleton body 14) may wholly extend around the gap portion 296 or may extend partially around the gap portion 296. In other words, the outer perimeter of the gap portion 296 may have an outer wall enclosing the gap portion 296. The top portion 16 may extend wholly around the gap portion 296, the first removable chamber 80, and the second removable chamber 90 in order to better secure a removable cap 12, 250 and/or 270 (as described above with reference to FIGS. 1, 8A, 8B).

FIG. 9 further illustrates how the gap portion 296 separates the bottle necks (not shown) by providing for a first ridge 292 and a second ridge 294. The connecting point of the first ridge 292 and the second ridge 294 is the upper portion of the central member 24 (dividing member). The separation of the upper portions of the removable chambers 80, 90 effectively provides for the separation of the liquids 84, 94 when desired to be separately accessed by a user of the bottle 10 (see FIGS. 1, 2). As a result, a height of the dividing member separating the one or more removable chambers is less than an overall height of the body skeleton and a connection region can be configured to be a maximum height of the dividing member.

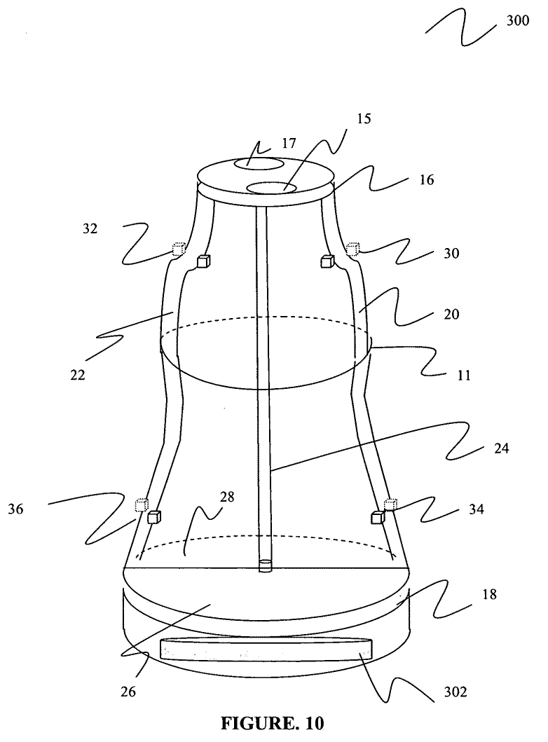

With reference to FIG. 10, there is presented a perspective view of a skeleton structure bottle having a single cooling element, in accordance with the present disclosure. The skeleton structure bottle 300 includes a cooling element 302. FIG. 10 includes similar elements as FIG. 1. Similar elements include a top portion 16, a base portion 18, a first side member 20, a second side member 22, a central member 24, a first base portion 26, a second base portion 28, a first set of top connection members 30, a second set of top connection members 32, a first set of bottom connection members 34, a second set of bottom connection members 36, a first ring 11, a first bottle opening 15, and a second bottle opening 17.

There are certain challenges that have developed in the use of sport bottles. For example, sport bottles are typically being utilized in an outdoor environment, which makes it very difficult to keep the contents cool. In most cases the sports bottle sits out in the sun or the hot air and rapidly loses the chilling effect of the liquid, with the result that an individual then have a warm liquid. This is highly undesirable as cool liquids are significantly more refreshing. In addition, with indoor health clubs/gyms being at room temperatures and warmer than preferred for a refreshing drink, many individuals may add ice to the drink to maintain it cooler. However, this can require time and effort in fitting the ice cubes individually into the bottle fill opening, and moreover dilutes all drinks other than water as the ice melts.

In FIG. 10 of the present disclosure, it is contemplated to use a single cooling element 302 positioned at the base portion 18 of the bottle 300. The cooling element 302 may be positioned in a separate compartment located at the bottom of both the first removable chamber 80 and the second removable chamber 90 in order to cool both liquids 84, 94 at the same time (see FIG. 2). It is noted that the cooling element 302 may be a removable cooling element that can be replaced at any time by the user of the bottle 300. The cooling element 302 may be any type of cooling element contemplated by one skilled in the art.

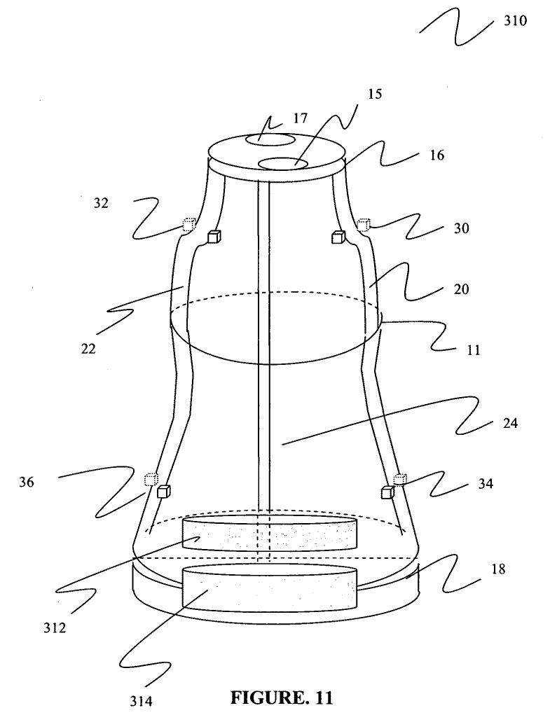

With reference to FIG. 11, there is presented a perspective view of a skeleton structure bottle having two cooling elements, in accordance with a third embodiment of the present disclosure. The skeleton structure bottle 310 includes a first cooling element 312 and a second cooling element 314. FIG. 11 includes similar elements as FIG. 1. Such similar elements include a top portion 16, a base portion 18, a first side member 20, a second side member 22, a central member 24, a first set of top connection members 30, a second set of top connection members 32, a first set of bottom connection members 34, a second set of bottom connection members 36, a first ring 11, a first bottle opening 15, and a second bottle opening 17.

In FIG. 11 of the present disclosure, it is contemplated to use two cooling elements, a first cooling element 312 and a second cooling element 314 positioned at the base portion 18 of the bottle 310. The first cooling element 312 and the second cooling element 314 may be positioned in a separate compartment (single compartment or dual compartment) located at the bottom of the first removable chamber 80 and the second removable chamber 90, respectively, in order to cool the first liquid 84 with the first cooling element 312 and to cool the second liquid 94 with the second cooling element 314 (see FIG. 2).

The first cooling element 312 may be positioned adjacent to the first base portion 26, whereas the second cooling element 314 may be positioned adjacent to the second base portion 28, respectively. In other words, each removable chamber 80, 90 may include its own separate cooling element for cooling each liquid. It is noted that the cooling elements 312, 314 may be removable cooling elements that can be replaced at any time by the user of the bottle 310. The cooling elements 312, 314 may be any type of cooling elements contemplated by one skilled in the art.

Moreover, while threaded connections are utilized to connect various components in the described embodiments, many other forms of connections, such as snap together connections, twist-to-lock connections and the like also can be utilized. The present disclosure may also include a twist-on or snap-on spout or nozzle, preferably of a tapered conical or substantially cylindrical shape, and internally divided. The spout or nozzle may be adapted to be sealed by an end cap, a plug, by helically twisting the “overcap” upon a “scaling rod”, or by sliding upon an internal shaft affecting a seal when screwed or pushed downwards towards the skeleton bottle configuration.

Optionally, the body of all bottles of the present disclosure may be constructed of a clear or transparent or translucent material in order to better identify the liquid contained within the one or more removable chambers. Optionally one or more of the removable chambers may be constructed of a clear or transparent or translucent material in order to better identify the liquids therein. In other words, some removable chambers may be clear and/or transparent, while others may not be, depending on desired applications.

Additionally, all the bottles of the present disclosure are not limited to any particular bottle shape or design. Although the bottles are described and depicted herein as being of generally cylindrical upstanding form, the configurations of the containers is a matter of design choice. The use of generally cylindrical containers is described because it gives the sports bottle a readily acceptable appearance and shape, and because generally cylindrical container shapes tend to work well if one also desires to make use of generally cylindrical, externally threaded container necks. Moreover, generally cylindrical containers tend to efficiently provide good fluid-carrying capacity at relatively low manufacturing cost. While opaque, single-thickness materials may be preferred for use, transparent or plural-layer materials may be used, if desired, to enhance visibility, to provide added insulating capability, or for other purposes.

Moreover, the one or more removable chambers of all the bottles of the present disclosure may be designed to contain different ratios of liquids. For example, a 50/50 ratio between a first chamber and a second chamber may be preferred (e.g., in a dual removable chamber skeleton bottle). However, it is envisioned that even a 1/3 to 2/3 ratio may be practical for certain applications.

Furthermore, all the bottles of the present disclosure may include one or more caps or lids, and each of the one or more caps or lids may have a strap connected to the body. All the bottles of the present disclosure may include one or more cooling elements to cool the liquids contained within the chambers or containers. All the bottles of the present disclosure may be of different widths and/or heights, and each chamber of all the bottles may be of a different width and/or height. All the bottles of the present disclosure may have different caps of different shapes and/or sizes with a plurality of fastening means. All the bottles of the present disclosure may include slidable orifices moving on a slidable track in a variety of tracks. All the bottles of the present disclosure may have interchangeable parts, such as interchangeable caps, orifices, side members, central members, etc.

All the bottles of the present disclosure may be constructed by any manufacturing means. For example, blow molding technology may be utilized. A plurality of different types of thermoplastic resins may be utilized in any type of blow molding techniques.

Concerning reusability, reusing items, such as a skeleton bottle, saves money, reduces waste, and is a way to do something positive for the environment. Reuse is a means to prevent solid waste from entering the landfill, improve our communities, and increase the material, educational and occupational wellbeing of our citizens by taking useful products discarded by those who no longer want them and providing them to those who do. Pollution prevention and waste minimization are realized by using the present skeleton structure bottle. The skeleton structure bottles of the present disclosure are eco-friendly and can be made of biodegradable materials. In addition, it is envisioned that the removable chambers are composed of eco-friendly and/or biodegradable materials that are reusable, renewable, and/or recyclable in order to preserve and protect the environment. It is highly desirable to produce removable chambers that are designed with biodegradable materials that are substances that will decompose in a natural environment.

Moreover, the skeleton bottle of the present disclosure is at least a two part bottle or a bottle including at least two separable components to form a bottle. In other words, the bottle of the present disclosure includes a first component (e.g., a skeleton structure) and a second component (e.g., a plurality of removable chambers). Thus, there are at least two separate and distinct components that are attachable to be other to form a single unit (i.e., a bottle). This is a multiple unit or multiple part/component bottle that forms a single unit.

Accordingly, the present disclosure prevents the mixing of contents of multiple chambers during the dispensing process, thus minimizing or even eliminating the risk that two liquids are simultaneously dispensed in an inadvertent manner by providing for one or more removable chambers attachable to a skeleton structure bottle that is designed is an environmentally friendly manner.

It will be understood that there are to be no limitations as to the dimensions and shape of the beverage bottle, including the storage compartment, or the materials from which the beverage bottle is manufactured. The bottles may be constructed to resemble any commercially available bottle for holding a liquid beverage and may be manufactured from any suitable plastic, glass or metal material. Furthermore, it should be understood that the beverage bottle of the present disclosure may be adapted to store any suitable liquid, such as, for example, water, juice, milk, carbonated sodas, protein shakes, energy drinks, beer, wine, and liquor.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

Having described the invention above, various modifications of the techniques, procedures, material and equipment will be apparent to those in the art. It is intended that all such variations within the scope and spirit of the appended claims be embraced thereby.

The foregoing examples illustrate various aspects of the invention and practice of the methods of the invention. The examples are not intended to provide an exhaustive description of the many different embodiments of the invention. Thus, although the foregoing invention has been described in some detail by way of illustration and example for purposes of clarity and understanding, those of ordinary skill in the art will realize readily that many changes and modifications can be made thereto without departing form the spirit or scope of the invention.

What is claimed is:

1. A bottle, comprising:
a first portion having one or more bottle openings;
a second portion being a base portion; and
a body portion extending from the second portion to the first portion, the body portion configured to be a skeleton structure;
wherein the skeleton structure is configured to receive one or more removable chambers.

2. The bottle according to claim 1, wherein the one or more bottle openings of the first portion are separated by a gap portion in order to provide separate fluid communication to the one or more removable chambers.

3. The bottle according to claim 1, wherein a height of a dividing member separating the one or more removable chambers is less than an overall height of the body portion and a connection region is configured to be a maximum height of the dividing member.

4. The bottle according to claim 1, wherein the first portion of the bottle is configured to be in suitable use with a removable cap having one or more cap openings.

5. The bottle according to claim 4, wherein the one or more cap openings of the removable cap are separated by a gap portion in order to provide separate fluid communication to the one or more removable chambers.

6. The bottle according to claim 4, wherein the removable cap includes a first orifice and a second orifice, the first orifice configured to be in fluid communication with a first removable chamber and the second orifice configured to be in fluid communication with a second removable chamber.

7. The bottle according to claim 4, wherein the removable cap includes a slidable orifice for separately providing access to a first liquid of a first removable chamber and a second liquid of a second removable chamber.

8. The bottle according to claim 7, wherein the slidable orifice locks in a first predetermined position for permitting access to the first liquid of the first removable chamber and locks in a second predetermined position for permitting access to the second liquid of the second removable chamber.

9. The bottle according to claim 4, wherein the removable cap includes a strap, the strap configured to secure the removable cap to the bottle.

10. The bottle according to claim 1, wherein a single removable chamber for holding a liquid is configured to be in suitable use with the skeleton structure, the single removable chamber further configured to be in suitable use with an orifice of a removable cap.

11. The bottle according to claim 1,
wherein a first removable chamber for holding a first liquid is configured to be in suitable use with the skeleton structure, the first removable chamber configured to be in suitable use with a first orifice of a removable cap; and
wherein a second removable chamber for holding a second liquid is configured to be in suitable use with the skeleton structure, the second removable chamber configured to be in suitable use with a second orifice of the removable cap.

12. The bottle according to claim 11, wherein the first removable chamber is a same volumetric size as the second removable chamber.

13. The bottle according to claim 11, wherein the first removable chamber is a different volumetric size than the second removable chamber.

14. The bottle according to claim 1, wherein the second portion of the bottle is configured to secure one or more cooling elements for cooling the one or more removable chambers.

15. The bottle according to claim 1, wherein the skeleton structure includes a central member configured to secure the first portion to the second portion.

16. The bottle according to claim 1,
wherein the skeleton structure includes a central member and a plurality of side members; and
wherein the central member and the plurality of side members are configured to secure the first portion to the second portion.

17. The bottle according to claim 1,
wherein the skeleton structure includes a plurality of members commencing on an inner surface of the first portion and terminating on an inner surface of the second portion; and
wherein the plurality of members are configured to be a number of different shapes.

18. The bottle according to claim 17, wherein each of the plurality of members includes one or more connecting members for receiving the one or more removable chambers.

19. A removable chamber, comprising:
a first removable chamber portion having an opening;
a second removable chamber portion being a base portion; and
a third removable chamber portion extending from the second removable chamber portion to the first removable chamber portion;
wherein the removable chamber is configured to be securedly fixed within a bottle having a skeleton structure.

20. The removable chamber according to claim 19, wherein the removable chamber holds a liquid.

21. The removable chamber according to claim 19, wherein the removable chamber includes one or more connecting members for being securedly fixed to the skeleton structure.

22. A method for manufacturing a bottle, the method comprising the steps of:
forming a first portion having one or more bottle openings;
forming a second portion being a base portion; and
forming a body portion extending from the second portion to the first portion, the body portion configured to be a skeleton structure;
wherein the skeleton structure is configured to receive one or more removable chambers.
